(19) United States
(12) Patent Application Publication
(10) Pub. No.: US 2026/0063816 A1
(43) Pub. Date: Mar. 5, 2026

(54) BAYESIAN TECHNIQUES OF HYPERPARAMETERS FOR TELECOMMUNICATION SYSTEMS

(71) Applicants: Schlumberger Technology Corporation, Sugar Land, TX (US); INSTITUT MINES-TELECOM, Palaiseau (FR)

(72) Inventors: Cheikh Malainine Cheikh Melainine, Clamart (FR); Arnaud Jarrot, Clamart (FR); François-Xavier SOCHELEAU, Clamart (FR); Arnaud Croux, Clamart (FR)

(21) Appl. No.: 18/823,361

(22) Filed: Sep. 3, 2024

(51) Int. Cl. G01V 1/30; G01V 1/38

(52) U.S. Cl. CPC G01V 1/30; G01V 1/38

(57) ABSTRACT

A method includes receiving input data from a receiver operating in a subterranean environment. The method also includes receiving a set of hyperparameters based on the input data, wherein the set of hyperparameters are associated with the reception of the input data in the subterranean environment. Further, the method includes utilizing a Bayesian optimization policy to iteratively select a plurality of observation points from the set of hyperparameters. Further still, the method includes obtaining a performance metric value for each of the selected observation points. Further still, the method includes selecting a hyperparameter from the set of hyperparameters based on the performance metric values. Even further, the method includes generating corrected input data based on the selected hyperparameter.

### BACKGROUND

The present disclosure generally relates to using Bayesian optimization techniques for selecting hyperparameters for oil and gas field telecommunication systems, such as underwater acoustic communication and mud pulse telemetry communication.

In any communication systems, each telecommunication block (e.g., transmitter or receiver) within the network faces a variety of challenges, including multipath reflections, Doppler spread, and noise sources, which can vary significantly across different operating conditions and geographic locations. In addition, the communication channels themselves can undergo unpredictable changes during transmission, requiring each block in the system to be robust to such variability to maintain optimal performance. In any case, these challenges result in unexpected or otherwise incorrect interpretation of transmitted data. Accordingly, it is desirable to develop techniques that reduce error rates in communication systems.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The brief summary presented above is intended only to familiarize the reader with certain aspects and contexts of embodiments of the present disclosure without limitation to the claimed subject matter.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 illustrates a schematic diagram of a shallow water seismic survey using multiple seismic measurements, in accordance with embodiments described herein;

FIG. 2 illustrates a schematic diagram of a wellsite system 200, in accordance with embodiments described herein;

FIG. 3 illustrates a flow diagram of a process for corrected input data using a Bayesian optimization policy, in accordance with embodiments described herein;

FIG. 4 illustrates a block diagram of a first example of a system for implementing the process of FIG. 3, in accordance with embodiments described herein;

FIG. 5 illustrates a block diagram of a second example of a system for implementing the process of FIG. 3, in accordance with embodiments described herein; and

FIG. 6 illustrates a block diagram of a third example of a system for implementing the process of FIG. 3, in accordance with embodiments described herein.

### DETAILED DESCRIPTION

Certain embodiments commensurate in scope with the present disclosure are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

As used herein, the term “coupled” or “coupled to” may indicate establishing either a direct or indirect connection (e.g., where the connection may not include or include intermediate or intervening components between those coupled), and is not limited to either unless expressly referenced as such. The term “set” may refer to one or more items. Wherever possible, like or identical reference numerals are used in the figures to identify common or the same elements. The figures are not necessarily to scale and certain features and certain views of the figures may be shown exaggerated in scale for purposes of clarification.

As used herein, the terms “inner” and “outer”; “up” and “down”; “upper” and “lower”; “upward” and “downward”; “above” and “below”; “inward” and “outward”; and other like terms as used herein refer to relative positions to one another and are not intended to denote a particular direction or spatial orientation. The terms “couple,” “coupled,” “connect,” “connection,” “connected,” “in connection with,” and “connecting” refer to “in direct connection with” or “in connection with via one or more intermediate elements or members.”

Furthermore, when introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment,” “an embodiment,” or “some embodiments” of the present disclosure are not intended to be interpreted as excluding the existence of additional embodiments that also incorporate the recited features. Furthermore, the phrase A “based on” B is intended to mean that A is at least partially based on B. Moreover, unless expressly stated otherwise, the term “or” is intended to be inclusive (e.g., logical OR) and not exclusive (e.g., logical XOR). In other words, the phrase A “or” B is intended to mean A, B, or both A and B.

Telecommunication blocks (e.g., transmitters and receivers) used in communications systems, such as underwater communications (e.g., acoustic communication) and downhole communication (e.g., mud-pulse telemetry), utilize tuning of numerous hyperparameters for optimal performance. In general, the hyperparameters correspond to transmission parameters of input data (e.g., raw data or raw sensor data). For example, the hyperparameters relate to the one or more media that the input data was transmitted through, a distance the input data traveled between a transmitter and a receiver, properties of the media that affect communication of signals, and the like. As one non-limiting example, the communication systems may utilize an equalizer that receives a distorted signal and one or more hyperparameters and outputs an estimated corrected signal. Conventional techniques to determine or select the one or more hyperparameters process may utilize an input provided by a domain specialist. For example, the domain specialist may select the hyperparameters based on their knowledge of the operation conditions where the transmission is taking place. However, an operator's initial input may not fully consider the actual operating conditions, and thus, may result in selecting hyperparameters that are not adapted based on the operating conditions. Further, it is presently recognized that the operating conditions may change over time and, as such, the initial selected hyperparameter may be ineffective after a time period. Other conventional techniques include optimization of the hyperparameters during a planning or advising phase. For example, the domain specialist may be involved prior to a job (e.g., a drilling job, a seismic data acquisition job, and other oil and gas related jobs) to select an hyperparameter. However, having the domain specialist select hyperparameters for each job may be relatively expensive. Further, the domain specialist may not be an expert in every operating condition, resulting in inaccurate selection of hyperparameters.

Accordingly, the present disclosure relates to techniques for determining hyperparameters by applying Bayesian optimization techniques. In general, the disclosed techniques provide an adaptive technique for determining or selecting hyperparameters parameters that adjusts the hyperparameters over time. For example, the disclosed techniques include receiving input data (e.g., a data packet(s), a data signal, raw data, raw sensor data) from a receiver that receives the input data from a transmitter. Further, the disclosed techniques include building an objective function that assigns a probability to each hyperparameter of a set of hyperparameters. To do so, a processor may utilize a Bayesian optimization policy to determine an observation point of the objective function. In general, the Bayesian optimization policy includes a relationship with performance metric values and hyperparameters. For example, the Bayesian optimization policy receives, as an input, a set of performance metric values for a set of hyperparameters. Then, the Bayesian optimization policy provides, as an output, a new hyperparameter that is not included in the set of hyperparameters having a highest probability of being the correct value. As referred to herein, “objective function” is a blackbox, or unknown function, may generally be represented as a function relating each of the set of hyperparameters to a performance metric (e.g., an error, an uncertainty). In general, the “observation point” is a selected hyperparameter having an associated performance metric. The Bayesian optimization policy may be an expected improvement optimization policy, a probability of improvement optimization policy, a Tree-structured Parzen estimator (TPE) optimization policy, and so on.

In any case, using the optimization policy, the processor selects a hyperparameter and determines the performance metric associated with the hyperparameter and determines an additional hyperparameter to select based on the performance metric of the previously selected hyperparameter. The processor iterates through these steps until a termination condition is reached (e.g., minimum or maximum of the performance metric is reached) and outputs the hyperparameter. Then, the processor utilizes hyperparameter to correct the input data received by the receiver. In some embodiments, the processor may determine or generate a control signal based on the corrected input data and outputs the control signal to control operation of oil and gas equipment (e.g., ocean equipment, downhole equipment, and so on). In this way, the disclosed techniques provide an improvement on hyperparameter selection by guiding the selection of hyperparameters by way of the Bayesian optimization policy. Accordingly, the disclosed techniques may reduce costs associated with deploying a domain specialist, reduce error rates in interpreting data transmitter in acoustic communication systems, mud pulse telemetry communication systems, and other communication systems that transmit data through irregular media. In some instances, the disclosed techniques may significantly reduce packet error rates in tests with both synthetic and real channels, thereby enhancing the efficiency of telecommunication systems across various settings.

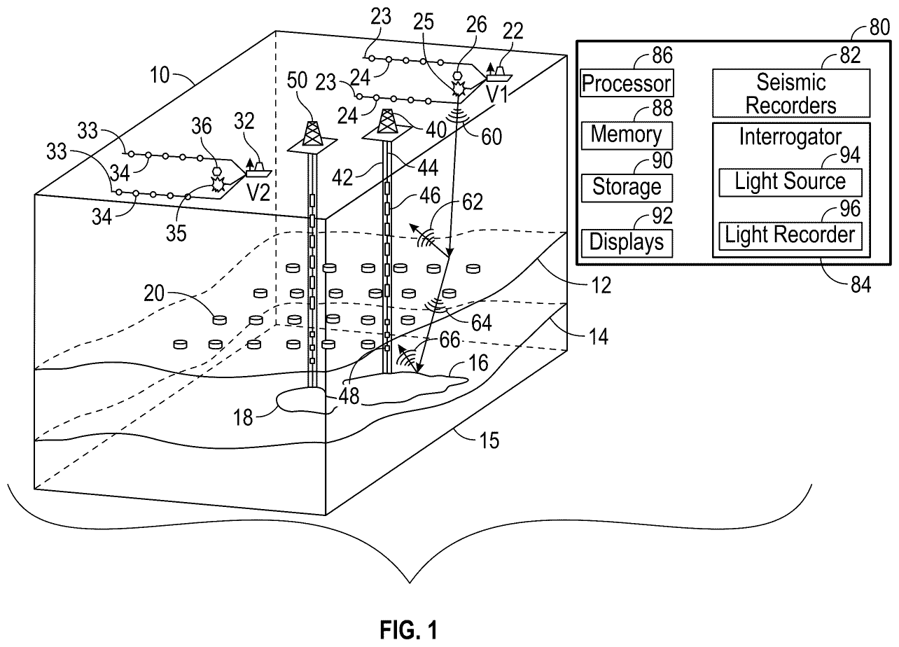

With the preceding in mind, turning now to the figures, FIG. 1 illustrates a schematic diagram of a shallow water seismic survey using multiple seismic measurements. A shallow water area may include a surface 10 and a water bottom 12. Water depth in the shallow water area may vary from a few meters to 150 meters. Multiple subsurface layers (e.g., subsurface layers 14 and 15) may locate beneath the water bottom 12. Geological formations, such as subsurface formations 16 and 18 embedded in the subsurface layers, may contain hydrocarbon deposits. Seismic data acquired in the shallow water seismic survey may be used to image the water bottom 12, the subsurface layers 14 and 15, and the subsurface formations 16 and 18. Images of subterranean geologic structures may provide indications of the hydrocarbon deposits.

The shallow water seismic survey may include ocean bottom node (OBN) measurement by employing multiple OBNs 20 on the water bottom 12. The OBNs may be deployed (e.g., using remotely operated vehicles (ROVs)) to selected locations and form a certain geometry (e.g., an OBN patch with 200 meters by 200 meters grid size). Each of the OBNs 20 may include one or more OBN sensors. The OBN sensors may include one or more geophones (e.g., single-component, two-component, three-component geophones). In some embodiments, the OBN sensors may also include hydrophones.

One or more seismic source vessels may be used in the shallow water seismic survey. For example, a source vessel 22 towing a seismic source 25 and another source vessel 32 towing another seismic source 35 may be used to create seismic waves propagating downward into the subterranean geologic structures. Each of the seismic sources 25 and 35 may include one or more source arrays and each source array may include a certain number of air guns.

The shallow water seismic survey may also include streamer measurement by employing multiple streamers traversing the shallow water. For example, the source vessel 22 may tow multiple (e.g., two, four, six, eight, or ten) streamers 23 along one sail line, and the source vessel 32 may tow multiple streamers 33 along another sail line. The streamer measurement may be acquired simultaneously with the OBN measurement using shots fired by the seismic sources 25 and 35. Each streamer may include multiple streamer sensors. For example, each of the streamers 23 may include streamer sensors 24 and each of the streamers 33 may include streamer sensors 34. The streamer sensors 24 and 34 may include hydrophones that create electrical signals in response to water pressure changes caused by reflected seismic waves that arrive at the hydrophones.

The shallow water seismic survey may also include near field hydrophone (NFH) measurement by employing multiple NFHs close to the seismic sources. For example, an NFH 26 may be deployed in close proximity to the seismic source 25 and another NFH 36 may be deployed in close proximity to the seismic source 35. In a shallow water environment, the NFH measurement may be used to improve estimates of near surface conditions and to create more accurate shallow velocity models. Moreover, the NFH measurement may provide small-offset data missing from streamer measurement that may be useful for multiple attenuation. Offset may be referred to as a distance between a seismic source and a seismic receiver or sensor. The NFH measurement may be combined with streamer measurement to improve seismic data processing such as multiple attenuation, wavelet estimation, and de-bubble.

The shallow water seismic survey may further include vertical seismic profile (VSP) measurement by employing seismic sensors (e.g., fiber-optic sensors, geophones, or hybrid sensors) in one or more wells. For example, a hybrid sensor array including fiber-optic sensors 46 and geophones 48 may be disposed along a wireline cable 44 deployed in a borehole 42 of a well 40, which may be drilled into the subsurface formation 16. Similar seismic sensors may be deployed in another well 50, which may be drilled into the formation 18. The fiber-optic sensors 46 may measure strains caused by reflected or refracted seismic waves traveling along the hybrid sensor array. The geophone 48 may measure ground motions (e.g., particle movements such as velocity and acceleration) caused by seismic waves traveling along the hybrid sensor array.

During the shallow water seismic survey, the seismic source 25 may be activated to generate seismic waves 60 traveling downward into the subterranean geologic structures. When the seismic waves 60 arrives at the water bottom 12, a portion of seismic energy contained in the seismic waves 60 is reflected by the water bottom 12. Reflected waves 62 travel upward and arrive at different sensors, such as the streamer sensors 24 and 34, the near field hydrophones 26 and 36, and the fiber-optic sensors 46, where they are measured by corresponding sensors. Another portion of the seismic energy contained in transmitted seismic waves 64 propagated through the water bottom 12 into the subsurface layer 14. A portion of seismic energy contained in the transmitted waves 64 is reflected by the subsurface formation 16. Reflected waves 66 travel upward and arrive at the different sensors, where they are measured by the corresponding sensors.

It should be noted that the elements described above with regard to the shallow water seismic survey are exemplary elements. For instance, some embodiments of the shallow water seismic survey may include additional or fewer elements than those shown. In some embodiments, the shallow water seismic survey may include different number of source vessels. In some embodiments, separated receiver vessels may be used to tow the streamers. In some embodiments, the streamer measurement may be acquired independently from the OBN measurement for operational or logistical reasons.

Seismic data simultaneously acquired from different sensors may be collected and processed by a processing system 80. The processing system 80 may include one or more seismic recorders 82, an interrogator 84, a processor 86, a memory 88, a storage 90, and one or more displays 92. The one or more seismic recorders 82 may receive ocean bottom node (OBN) data from OBNs 20, streamer data from streamer sensors 24 and 34, near field hydrophone (NFH) data from the NFHs 26 and 36, and a portion of vertical seismic profile (VSP) data from geophones 48. The interrogator 84 may receive another portion of VSP data from the fiber-optic sensors 46. Collected data may be processed by the processor 86 using processor-executable code stored in the memory 88 and the storage 90. The processed data may be stored in the storage 90 for later usage. Processing results may be displayed via the one or more displays 92.

The interrogator 84 may include a light source 94 that may provide source light signals (e.g., laser impulses) for the fiber-optic sensors 46. For example, the light source 94 may include wavelength tunable lasers (e.g., semiconductor lasers), such as distributed Bragg reflector (DBR) laser, vertical cavity surface-emitting laser (VCSEL), external cavity laser, distributed feedback (DFB) laser, or other suitable lasers. The interrogator 84 may also include a light recorder 96 that may receive light signals (e.g., back scattered light signals associated with local measurement of dynamic strains caused by incident seismic waves) from the fiber-optic sensors 46 and convert the light signals to electrical signals (e.g., using photodetectors).

The processor 86 may be any type of computer processor or microprocessor capable of executing computer-executable code. The processors 86 may include single-threaded processor(s), multi-threaded processor(s), or both. The processors 86 may also include hardware-based processor(s) each including one or more cores. The processors 86 may include general purpose processor(s), special purpose processor(s), or both. The processors 86 may be communicatively coupled to other components (such as one or more seismic recorders 82, interrogator 84, memory 88, storage 90, and one or more displays 92).

The memory 88 and the storage 90 may be any suitable articles of manufacture that can serve as media to store processor-executable code, data, or the like. These articles of manufacture may represent computer-readable media (e.g., any suitable form of memory or storage) that may store the processor-executable code used by the processor 86 to perform the presently disclosed techniques. The memory 88 and the storage 90 may also be used to store data described (e.g., fiber sensor data, geophone data), various other software applications for seismic data analysis and data processing. The memory 88 and the storage 90 may represent non-transitory computer-readable media (e.g., any suitable form of memory or storage) that may store the processor-executable code used by the processor 86 to perform various techniques described herein. It should be noted that non-transitory merely indicates that the media is tangible and not a signal.

The one or more displays 92 may operate to depict visualizations associated with software or executable code being processed by the processor 86. The display 92 may be any suitable type of display, such as a liquid crystal display (LCD), plasma display, or an organic light emitting diode (OLED) display.

It should be noted that the components described above with regard to the processing system 80 are exemplary components and the processing system 80 may include additional or fewer components as shown. For example, the processing system 80 may include one or more communication interfaces to send commands to different seismic acquisition systems and receive measurement from the different seismic acquisition systems. In any case, the processing system 80 may receive acoustic communications between communication blocks positioned on the water bottom 12 and/or at the surface. By utilizing the disclosed techniques, the processing system 80 may more accurately interpret data, which may be utilized to determine control signals to control the equipment on the water bottom and/or at the surface.

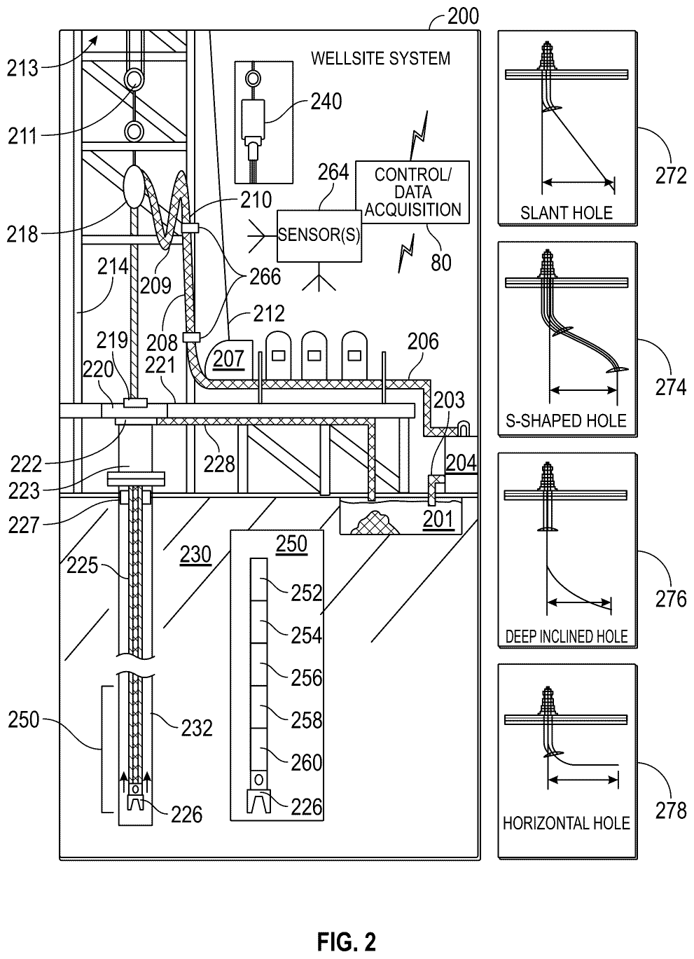

As described herein, the disclosed techniques may be utilized in mud-pulse telemetry communication systems. With this in mind, FIG. 2 shows another example of a wellsite system 200 (e.g., at a wellsite that may be onshore or offshore) in which the embodiments described herein may also be employed. As shown, the wellsite system 200 can include a mud tank 201 for holding mud and other material (e.g., where mud can be a drilling fluid), a suction line 203 that serves as an inlet to a mud pump 204 for pumping mud from the mud tank 201 such that mud flows to a vibrating hose 206, a drawworks 207 for winching drill line or drill lines 212, a standpipe 208 that receives mud from the vibrating hose 206, a kelly hose 209 that receives mud from the standpipe 208, a gooseneck or goosenecks 210, a traveling block 211, a crown block 213 for carrying the traveling block 211 via the drill line or drill lines 212 (see, e.g., the crown block 173 of FIG. 1), a derrick 214 (see, e.g., the derrick 172 of FIG. 1), a kelly 218 or a top drive 240, a kelly drive bushing 219, a rotary table 220, a drill floor 221, a bell nipple 222, one or more blowout preventors (BOPs) 223, a drillstring 225, a drill bit 226, a casing head 227 and a flow pipe 228 that carries mud and other material to, for example, the mud tank 201.

In the example system of FIG. 2, a borehole 232 is formed in subsurface formations 230 by rotary drilling; noting that various example embodiments may also use one or more directional drilling techniques, equipment, etc. As shown in the example of FIG. 2, the drillstring 225 is suspended within the borehole 232 and has a drillstring assembly 250 that includes the drill bit 226 at its lower end. As an example, the drillstring assembly 250 may be a bottom hole assembly (BHA).

The wellsite system 200 can provide for operation of the drillstring 225 and other operations. As shown, the wellsite system 200 includes the traveling block 211 and the derrick 214 positioned over the borehole 232. As mentioned, the wellsite system 200 can include the rotary table 220 where the drillstring 225 pass through an opening in the rotary table 220. As shown, the well system includes the data acquisition system 80. In the example of FIG. 2, the uphole control and/or data acquisition system 80 may include circuitry to sense pressure pulses generated by telemetry equipment 252 and, for example, communicate sensed pressure pulses or information derived therefrom for process, control, etc.

The assembly 250 of the illustrated example includes a logging-while-drilling (LWD) module 254, a measurement-while-drilling (MWD) module 256, an optional module 258, a rotary-steerable system (RSS) and/or motor 260, and the drill bit 226. Such components or modules may be referred to as tools where a drillstring can include a plurality of tools. FIG. 2 also shows some examples of types of holes that may be drilled. For example, consider a slant hole 272, an S-shaped hole 274, a deep inclined hole 276 and a horizontal hole 278.

The wellsite system 200 can include one or more sensors 264 that are operatively coupled to the control and/or data acquisition system 80. As an example, a sensor or sensors may be at surface locations. As an example, a sensor or sensors may be at downhole locations. As an example, a sensor or sensors may be at one or more remote locations that are not within a distance of the order of about one hundred meters from the wellsite system 200. As an example, a sensor or sensor may be at an offset wellsite where the wellsite system 200 and the offset wellsite are in a common field (e.g., oil and/or gas field). As an example, one or more of the sensors 264 can be provided for tracking pipe, tracking movement of at least a portion of a drillstring, etc.

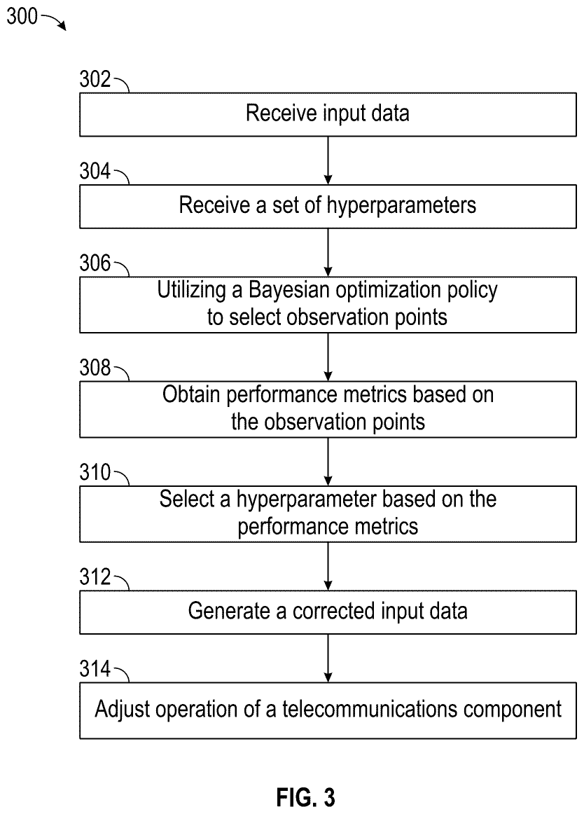

As discussed above, the disclosed techniques utilize a Bayesian optimization policy to guide selection of hyperparameters, thereby at least partially automating the selection of hyperparameters and also providing adaptive selection of the hyperparameters. To illustrate this, FIG. 3 shows an example method 300 for adjusting operation a telecommunications component based on a selected hyperparameter used to correct input data. In general, the method 300 is described as being performed by the processor 86 of the processing system 80. However, it should be noted that any suitable processor may perform the method 300. Further, although described as being perform by the processor 86, it should be noted that the method 300 may be performed by one or more processors of a control system. Further, although the discussion below relates to adjusting operation of a telecommunications component, it should be noted that the disclosed techniques may additionally or alternatively be used to control other downhole and/or ocean equipment, described above with reference to FIGS. 1 and 2.

At block 302, the processor 86 receives input data. In general, the input data may be data transmitted by a transmitter and received by a receiver. In some embodiments, the input data may be a data packet, raw sensor data, mud-pulse telemetry data, acoustic data, and so on.

At block 304, the processor 86 receives a set of hyperparameters. In general, the hyperparameters relate to reception or receiver parameters. For example, the hyperparameters may include receiver parameters such as equalizer parameters, tracking loops parameters, synchronization thresholds, numbers of channels, diversity gains, and so on. As another non-limiting example, the hyperparameters may include transmitter parameters such as bit rate, frequency, modulation, amplitude, precursor length, and so on. As another non-limiting example, the hyperparameters may include network parameters such as packet length, routing table, channel access parameters, and so on.

At block 306, the processor 86 utilizes a Bayesian optimization policy to iteratively select observation points from the a set of hyperparameters. For each of the selectively observation points, the processor 86, at block 308 determines, receives, or otherwise obtains performance metric values. Then, at block 310, the processor 86 selects a hyperparameter from the set of hyperparameters based on the performance metric values. At block 310, the processor 86 selected a hyperparameter based on the performance metric values. In general, the hyperparameter at block 310 may be referred to as a correct hyperparameter, optimized hyperparameter, or otherwise a hyperparameter that satisfies a performance metric. It should be noted that blocks 306, 308, and 310 may occur in an iterative process. For example, the processor 86 may receive a set of parameters and a corresponding set of performance metric values. Then, based on the set of parameters and the corresponding metric values, the processor 86 may utilize the Bayesian optimization policy to select a new hyperparameter. This process may repeat until a performance metric is satisfied, such as the error between a new hyperparameter and a previously selected hyperparameter being within a threshold range. Accordingly, the output hyperparameter (e.g., corresponding to the new hyperparameter associated with the satisfied performance metric) may be used to adjust the input data as described herein. Blocks 306, 308, and 310 are described in more detail below.

In general, it is presently recognized that Bayesian Optimization may be useful for determining hyperparameters for systems that may lack a useful or accurate analytical description, where it may be difficult to determine gradients of the hyperparameters, and where it may be otherwise expensive to determine hyperparameters. Such systems may be referred to as a “blackbox”. Blackbox optimization problems may be formulated as follows:

$${θ}^{*} = arg {min}_{θ ∈ Θ} ( f ( θ ) ) \qquad ( 1 )$$

In equation 1, ƒ is a blackbox, θ are the hyperparameters, θ* are the optimal hyperparameters and Θ is the domain of the hyperparameters. In one non-limiting example, the hyperparameters θ are those of the receiver and ƒ the receiver performance. Due to the lack of information about the objective function, which is the case for blackbox function in general and the telemetry systems as discussed herein, Bayesian Optimization algorithms may model ƒ as a collection of Gaussian random variable ƒ_{θ} representing a score associated with θ:

$$f ∼ GN ( μ , κ ) \qquad ( 2 )$$

In equation 2, μ: Θ→R and K: Θ×Θ→R are functions that give to each hyperparameter θ respectively a mean value, and a covariance with other hyperparameters, respectively. One non-limiting example of a Bayesian Optimization techniques utilizing a Bayesian optimization policy in accordance with the present techniques is described below.

Given a budget of N iterations, the processor 86 may perform a warm-up session in which a data set with n-usually random-hyperparameters and associated observations is initialized (D₀≙{(θᵢ,ƒ(θᵢ))}ᵢ₌₀ⁿ).

In the remaining N−n iterations, the processor 86 may determine a next observation point θⱼ, given Dⱼ₋₁, using a policy π, and Dⱼ is updated with {(θⱼ,ƒ(θⱼ))}, where j is the iteration index. When a Gaussian process is used to model ƒ, the model is updated with θⱼ and ƒ(θⱼ) as follows in equations 3 and 4:

$$μ ( θ ) = μ ( θ ) + κ ( θ , {θ}_{j} ) {κ ( θ , θ )}^{- 1} ( f ( {θ}_{j} ) - μ ( θ ) ) , \qquad ( 3 )$$

$$κ ( θ , {θ}^{′} ) = κ ( θ , {θ}^{′} ) - κ ( θ , {θ}_{j} ) {κ ( θ , θ )}^{- 1} κ ( {θ}_{j} , {θ}^{′} ) \qquad ( 4 )$$

In some embodiments, the Bayesian optimization policy may be an Expected Improvement optimization policy, where:

$${π}_{EI} ( D ) = {max}_{θ} \int max ( {y}^{*} - f , 0 ) p ( f \vert D ) df \qquad ( 5 )$$

In equation 5, y* corresponds to the best ƒ(θ) in D.

As another nonlimiting example, the Bayesian optimization policy may be the Tree-structured Parzen estimator (TPE) optimization policy. In the TPE, the approach includes Segmenting the D into two subsets using a quantile y: the good population with the γ×N hyperparameters with respect to their respective ƒ(θ) and the bad population composed of the remaining hyperparameters in D. Further, the TPE approach includes Estimate the probability density functions of g and l using Gaussian kernel functions. This gives us the following policy:

$${π}_{TPE} ( D ) = {max}_{θ} \frac{g ( θ )}{l ( θ )} \qquad ( 6 )$$

Using the selected hyperparameter, the processor 86, at block 312, generates a corrected input data. To do so, the processor 86 may provide the selected hyperparameter (e.g., the optimized hyperparameter) into a model that interprets the input data.

At block 314, the processor 86 adjust operation of a computing component using the corrected input data. In general, adjusting the operation may include displaying a visualization associated with the input data (e.g., in instances where the input data corresponds to a data stream), outputting an alert (e.g., if the data indicates an occurrence of an anomaly), generating a control signal and outputting the control signal (e.g., if a signature of the input data relates to a control action), or a combination thereof. In some embodiments, the computing components may be downhole components (e.g., as described in FIG. 2), ocean components (e.g., as described in FIG. 1), or other components that may utilize the corrected input data.

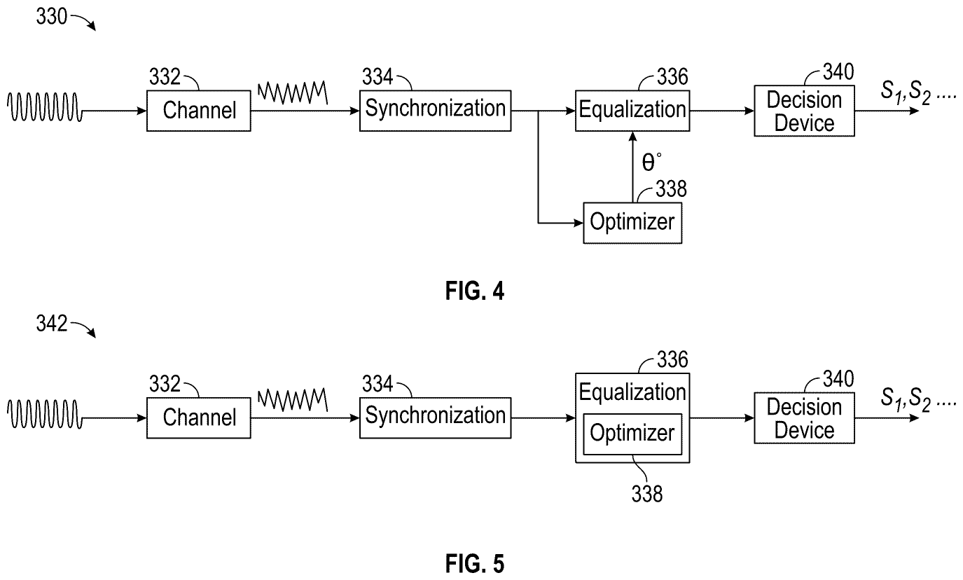

As one non-limiting example, the processor 86 may provide the selected hyperparameter as input to a DFE. This process is generally illustrated in FIGS. 4 and 5. FIG. 4 shows a block diagram of a system 330 for generating a corrected input data using predictive update techniques. FIG. 5 shows a block diagram of a system 342 for generating a corrected input data using exhaustive update techniques. As shown, the systems 330 and 342 include a channel 332, a synchronization 334, an equalizer 336, an optimizer 338 and a decision device 340. In FIG. 4, the equalizer 336 generally runs in parallel with the optimizer 338.

In the illustrated embodiment, the optimizer 338 can operate concurrently with the equalizer 336, enabling real-time updates of the hyperparameters. In this mode, a separate processing block (e.g., the decision device 340) is evaluating the performances of the equalizer 336 in a separate copy of the initial equalizer. In this configuration, an independent processing block assesses the equalizer's performance using a duplicate of the original equalize 336. When the optimizer 338 identifies a superior set of parameters, it shares them with the original equalizer 336. By utilizing the same input as the equalizer 336, the optimizer 338 calculates the optimal hyperparameters θ* corresponding to this input received at the channel 332. This cycle is repeated continuously until a performance metric is satisfied. In some embodiments, the optimizer 338 may trigger once the performance metrics of the receiver degrades below a certain threshold.

Alternatively, the command may cause the processor 86 to perform an exhaustive update of the hyperparameter, whereby the optimizer 338 operates directly on the same data block processed by the equalizer 336. As such, the optimizer 338 continuously adjusts and evaluates different sets of hyperparameters until a satisfying set is found. Once the optimizer 338 identifies the best set of hyperparameters for the current data block, only the results from these optimal parameters are retained. The process then progresses to the next data block, where the optimizer 338 begins again, applying the same rigorous evaluation and adjustment to find the most effective parameters for each new data segment. This integrated approach ensures that the equalizer is consistently operating with the most optimized parameters, enhancing overall performance and efficiency.

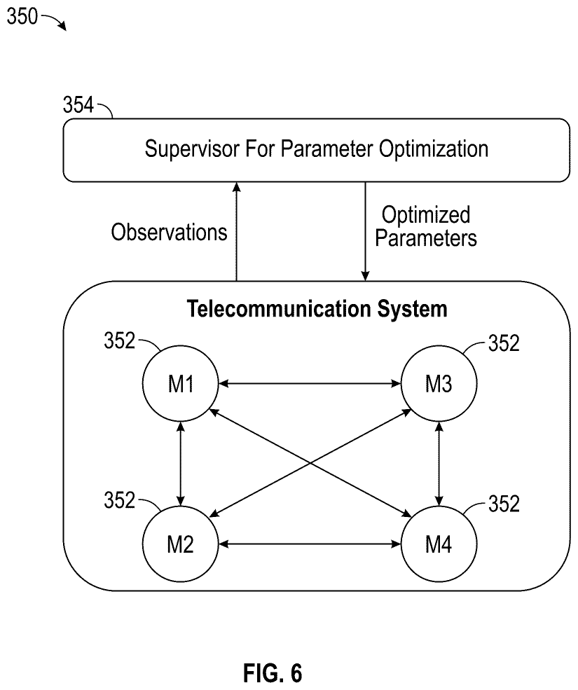

In some embodiments, the disclosed techniques may include a supervisory monitoring, determining, and adjusting of hyperparameters. This is generally illustrated in FIG. 6. As shown, the telecommunication system 350 of FIG. 6 includes multiple modems 352 and a telecommunication control system 354.

In the illustrated embodiment, four modems 352 are shown (e.g., M1, M2, M3, and M4). The modems 352 can communicate with each other via respective transmitters and receivers. The telecommunication control system 354 generally operates as a supervisor for optimizing certain hyperparameters of the telecommunication system 350. The telecommunication control system 354 can exchange information with the modems 352. The modems 352 can report some data such as channel information or performance metrics, and the telecommunication control system 354 can publish optimized hyperparameters to the modems. The hyperparameters are optimized using the blackbox optimization procedure proposed in this patent. The telecommunication control system 354 can take the form of one software for all modems, which would be applicable to a network. The telecommunication control system 354 can run digital simulations of at least part of the telecommunication systems. With this concept, the telecommunication control system 354 may be viewed as a digital twin of the telecommunication system, with an ability to optimize hyperparameters of the system. In such an embodiment, the modems 352 may report some channel side information during the operations. The side information is used to run simulations of the telecommunication systems 350. Using the simulations, it is possible to run the Bayesian optimizer to calculate some optimized hyperparameters of the system.

The technical effect of the disclosed embodiments includes reducing packet error rates in tests with both synthetic and real channels, thereby enhancing the efficiency of telecommunication systems across various settings.

The subject matter described in detail above may be defined by one or more clauses, as set forth below.

A method includes receiving input data from a receiver operating in a subterranean environment. The method also includes receiving a set of hyperparameters based on the input data, wherein the set of hyperparameters are associated with the reception of the input data in the subterranean environment. Further, the method includes utilizing a Bayesian optimization policy to iteratively select a plurality of observation points from the set of hyperparameters. Further still, the method includes obtaining a performance metric value for each of the selected observation points. Further still, the method includes selecting a hyperparameter from the set of hyperparameters based on the performance metric values. Even further, the method includes generating corrected input data based on the selected hyperparameter.

The method of any preceding claim, adjusting operation of a computing component based on the corrected input data.

The method of any preceding claim, wherein the input data comprises acoustic data.

The method of any preceding claim, wherein the hyperparameter corresponds to a transmission medium of the input data.

The method of any preceding claim, wherein the input data comprises mud pulse telemetry data.

The method of any preceding claim, further comprising synchronizing the input data and applying the Bayesian optimization policy to determine the hyperparameter based on the synchronized input data.

The method of any preceding claim, further comprising receiving additional raw sensor data transmitted after the raw sensor data and adjusting the additional raw sensor data by applying the hyperparameter.

The method of any preceding claim, wherein the optimization policy comprises an expected improvement optimization policy.

The method of any preceding claim, wherein the optimization policy comprises a probability of improvement optimization policy.

The method of any preceding claim, wherein the optimization policy comprises a Tree-structured Parzen estimator (TPE) technique.

The method of any preceding claim, wherein the telecommunications component comprises a transmitter, a receiver, a decision feedback equalizer, a modem, or a combination thereof.

A system includes an equalizer configured to receive a plurality of data packets. The system also includes an optimizer configured to receive the plurality of data packets. The optimizer is also configured to obtain a set of hyperparameters corresponding to reception of the plurality of data packets. Further, the optimized is configured to utilize a Bayesian optimization policy to iteratively select a plurality of observation points from the set of hyperparameters. Further still, the optimizer is configured to obtain a performance metric value for each of the selected observation points. Even further, the optimized is configured to select a hyperparameter from the set of hyperparameters based on the performance metric values. Even further, the optimized is configured to transmit the selected hyperparameter to the equalizer, wherein the equalizer is configured to correct the plurality of data packets based on the hyperparameter.

The system of any preceding claim, wherein the equalizer runs in parallel with the optimizer, wherein the optimizer is configured to determine the hyperparameter by predicting the hyperparameter.

The system of any preceding claim, wherein the optimizer is configured to determine a hyperparameter for each data packet and continuously adjust each data packet of the plurality of data packets based on the hyperparameter for each data packet.

The system of any preceding claim, comprising a decision device configured to receive the corrected plurality of data packets.

The system of any preceding claim, wherein the plurality of data packets comprises underwater acoustic data.

The system of any preceding claim, wherein the plurality of data packets comprises underwater acoustic data.

A system includes a plurality of telecommunication blocks. The system also includes a control system comprising one or more processors, wherein the control system is configured to receive input data transmitted between the plurality of telecommunication blocks. The control system is also configured to receive a set of hyperparameters based on the input data, wherein the set of hyperparameters are associated with the reception of the input data in a subterranean environment. Further, the control system is configured to utilize a Bayesian optimization policy to iteratively select a plurality of observation points from the set of hyperparameters. Further still, the control system is configured to obtain a performance metric value for each of the selected observation points. Even further, the control system is configured to select a hyperparameter from the set of hyperparameters based on the performance metric values. Even further, the control system is configured to generate corrected input data based on the hyperparameter.

The system of any preceding claim, wherein the control system is configured to generate a control signal that adjusts operation of a downhole equipment, ocean equipment, or a combination thereof, based on the corrected input data.

The system of any preceding claim, wherein the control system is configured to utilize the Bayesian optimization policy to determine the observation point based on the set of hyperparameters by determining a hyperparameter that satisfies a performance metric.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principals of the disclosure and its practical applications, to thereby enable others skilled in the art to best utilize the disclosure and various embodiments with various modifications as are suited to the particular use contemplated.

Finally, the techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A method, comprising
receiving input data from a receiver operating in a subterranean environment;
receiving a set of hyperparameters based on the input data, wherein the set of hyperparameters are associated with the reception of the input data in the subterranean environment;
utilizing a Bayesian optimization policy to iteratively select a plurality of observation points from the set of hyperparameters;
obtaining a performance metric value for each of the selected observation points;
selecting a hyperparameter from the set of hyperparameters based on the performance metric values; and
generating corrected input data based on the selected hyperparameter.

2. The method of claim 1, adjusting operation of a computing component based on the corrected input data.

3. The method of claim 1, wherein the input data comprises acoustic data.

4. The method of claim 1, wherein the hyperparameter corresponds to a transmission medium of the input data.

5. The method of claim 1, wherein the input data comprises mud pulse telemetry data.

6. The method of claim 1, further comprising synchronizing the input data and applying the Bayesian optimization policy to determine the hyperparameter based on the synchronized input data.

7. The method of claim 1, further comprising:
receiving additional raw sensor data transmitted after the raw sensor data; and
adjusting the additional raw sensor data by applying the hyperparameter.

8. The method of claim 1, wherein the optimization policy comprises an expected improvement optimization policy.

9. The method of claim 1, wherein the optimization policy comprises a probability of improvement optimization policy.

10. The method of claim 1, wherein the optimization policy comprises a Tree-structured Parzen estimator (TPE) technique.

11. The method of claim 1, wherein the telecommunications component comprises a transmitter, a receiver, a decision feedback equalizer, a modem, or a combination thereof.

12. A system, comprising:
an equalizer configured to receive a plurality of data packets;
an optimizer configured to:
receive the plurality of data packets;
obtain a set of hyperparameters corresponding to reception of the plurality of data packets;
utilize a Bayesian optimization policy to iteratively select a plurality of observation points from the set of hyperparameters;
obtain a performance metric value for each of the selected observation points;
select a hyperparameter from the set of hyperparameters based on the performance metric values; and
transmit the selected hyperparameter to the equalizer, wherein the equalizer is configured to correct the plurality of data packets based on the hyperparameter.

13. The system of claim 12, wherein the equalizer runs in parallel with the optimizer, wherein the optimizer is configured to determine the hyperparameter by predicting the hyperparameter.

14. The system of claim 12, wherein the optimizer is configured to determine a hyperparameter for each data packet and continuously adjust each data packet of the plurality of data packets based on the hyperparameter for each data packet.

15. The system of claim 12, comprising a decision device configured to receive the corrected plurality of data packets.

16. The system of claim 12, wherein the plurality of data packets comprises underwater acoustic data.

17. The system of claim 12, wherein the plurality of data packets comprises underwater acoustic data.

18. A system comprising:
a plurality of telecommunication blocks; and
a control system comprising one or more processors, wherein the control system is configured to:
receive input data transmitted between the plurality of telecommunication blocks;
receive a set of hyperparameters based on the input data, wherein the set of hyperparameters are associated with the reception of the input data in a subterranean environment;
utilize a Bayesian optimization policy to iteratively select a plurality of observation points from the set of hyperparameters;
obtain a performance metric value for each of the selected observation points;
select a hyperparameter from the set of hyperparameters based on the performance metric values; and
generate corrected input data based on the hyperparameter.

19. The system of claim 18, wherein the control system is configured to generate a control signal that adjusts operation of a downhole equipment, ocean equipment, or a combination thereof, based on the corrected input data.

20. The system of claim 18, wherein the control system is configured to utilize the Bayesian optimization policy to determine the observation point based on the set of hyperparameters by determining a hyperparameter that satisfies a performance metric.
